(19) United States
(12) Patent Application Publication
(10) Pub. No.: US 2003/0194980 A1
(43) Pub. Date: Oct. 16, 2003

(54) Method and apparatus for indicating low signal quality in a digitized audio environment

(76) Inventors: Eugene H. Peterson III, Forest, VA (US); Paul Goodjohn, Lynchburg, VA (US)

Correspondence Address: Tyco Technology Resources, Suite 450, 4550 New Linden Hill Road, Wilmington, DE, 19808-2952, US

(21) Appl. No.: 10/119,585

(22) Filed: Apr. 10, 2002

(51) Int. Cl. H04B 17/00

(52) U.S. Cl. 455/226.1; 455/226.2; 455/296

(57) ABSTRACT

In accordance with the present invention, the quality of a received digital signal is determined by the receiver, such as by observing the received signal strength indication (RSSI) and/or the bit error rate (BER). When the quality drops below a first threshold, the receiver injects white noise into the reproduced audio signal to simulate the noise that typically accompanies an analog wireless signal of low quality. The amount of injected white noise may be increased as the signal quality continues to decrease beyond the first threshold. Preferably, at a second threshold at which the receiver can no longer reassemble the received signal, the white noise is muted to audibly indicate to the user that the signal has been lost.

### FIELD OF THE INVENTION

The invention relates to digital radio communications, particularly in the public safety two-way radio environment, such as police, fire or park ranger radio systems. More particularly, the invention pertains to indicating low signal strength of digital radio signal reception.

### BACKGROUND OF THE INVENTION

Radio frequency (RF) voice communication over the air (i.e., wirelessly) is becoming increasingly more prevalent. Digital cellular telephones, of course, are the most ubiquitous example of such communications systems. However, other digital wireless voice communication systems include public safety, two-way radio systems, such as those used by police departments, fire departments, park ranger systems, private livery companies and other private of public organizations with mobile vehicle fleets. In wireless digital voice communications systems, an audio signal detected by a transducer, such as a microphone on the radio unit, and transformed into an analog electrical signal. The analog electrical signal is converted to a digital bit stream and, commonly, highly compressed and/or encrypted into a different bit stream. That bit stream is modulated onto a carrier wave and supplied to an antenna for transmission through the air. As in any wireless communications system, there are many factors that can affect the quality of a signal received by the receiving node, (e.g., radio or cell phone). Signal quality generally decreases through such noise-inducing effects as interference, fading, low signal, and other similar factors. These effects are significantly a function of distance between the transmitting antenna and the receiving antenna. In analog wireless communications systems such as analog cellular telephones or AM or FM radio, as audio signal quality at the receiver decreases, there is a definite and perceptible decrease in the quality of the sound that is reproduced from the received signal. For instance, as the quality of an analog audio signal decreases, it is typically accompanied by the audible manifestation of noise mixed with the true audio signal. Two of the more common noise manifestations are “static”, which generally is white noise mixed in with the true signal and “popping”, which is due to fading. Such noise is present and becomes apparent to the naked ear while the signal is still good enough quality for the person at the receiving node to understand the speaker's words. The noise steadily increases as the signal quality decreases. Accordingly, as the quality of an analog wireless signal decreases, the person at the receiving node has ample warning of the decreasing signal quality by virtue of the increasing noise and can still receive the actual information for a long time after the noise becomes audibly apparent in the audio signal reproduced by the receiver.

However, in digital wireless communication systems, there typically is very little audible manifestation of a decrease in signal quality until the point at which the received signal is so deteriorated as to be unable to decipher any useful information from it. Particularly, at the receiver, many different kinds of digital error correction algorithms are run on the data to extract or estimate the true signal even as signal quality decreases. Accordingly, from the human operator's perspective at the receiver, there commonly is no audible indication of decreasing signal strength until there is a catastrophic failure of the link and the recovered audio is lost entirely.

Many cellular telephones have a visual display unit that includes a signal strength indicator that provides visual feedback as to signal quality. However, such visual indicators require conscious thought of the user to actively monitor this indicator. Users commonly look at the visual display only after the signal is already degraded. Even further, radio users in the public safety environment often use their radios while in the process of performing other public safety tasks requiring a substantial amount of their attention, particularly, their visual attention. Hence, it is often impractical to look at the visual indicator of signal quality. Even further, public safety officers typically wear the main radio unit with the visual signal quality indicator on their hips and simply have a microphone unit near their mouth. Accordingly, it may, in fact, be very difficult for them to look at the signal strength indicator even if they thought of doing so.

As the number of wireless devices sharing the available bandwidth increases, compression algorithms are becoming more and more severe so that each communication channel requires as little bandwidth as possible. Accordingly, the receivers are receiving smaller and smaller bits per unit of information, which the receivers then decompress, convert to analog, and feed to a transducer, e.g., a speaker, to reproduce the original audio/voice data. Accordingly, with the combination of extensive error correction algorithms and highly compressed data, sound quality commonly can be maintained at an excellent level as the signal quality decreases, followed by an abrupt, total or near total loss of the ability to reproduce the data.

Further, the advent of digital communication networks for public safety officers is a relatively recent event. Many public safety officers are accustomed to analog wireless communications systems and, thus, virtually intuitively recognize from the aforementioned audible cues in the received signal, such as static and popping, when the signal quality is degrading. Accordingly, they are instantly made aware of the decreasing signal quality and can move toward a window or take other action appropriate in the given situation. For instance, in such circumstances, the signal they are transmitting back to the other node with which they are communicating also is likely to be received at the receiving node with low quality. Accordingly, almost intuitively, experienced public safety officers begin speaking more clearly and/or repeating themselves when they consciously or subconsciously detect these audible cues indicative of low signal quality. Such audible cues are not present when they switch to a digital wireless communication system.

Accordingly, it is an object of the present invention to provide an improved method and apparatus for indicating low signal quality in a digitized audio environment.

### SUMMARY OF THE INVENTION

In accordance with the present invention, the receiver determines the quality of a received digital signal, such as by observing the received signal strength indication (RSSI) and/or the bit error rate (BER). When the quality drops below a certain threshold, the receiver injects white or colored noise into the reproduced audio signal to simulate the noise that typically accompanies an analog wireless signal of low quality. The amount of injected noise may be increased as the signal quality continues to decrease beyond the threshold. Preferably, at the point where the receiver can no longer reassemble the received signal, the noise is muted to audibly indicate that the signal has been lost.

### BRIEF DESCRIPTION OF THE DRAWINGS

FIG. 1 is a block diagram illustrating the general components of a receiver in accordance with one embodiment of the present invention.

FIG. 2A is a graph illustrating signal quality as a function of RSSI.

FIG. 2B is a graph illustrating noise injection level as a function of RSSI.

FIG. 3A is a graph illustrating bit error rate as a function of received signal quality.

FIG. 3B is a graph illustrating noise injection level as a function of bit error rate.

### DETAILED DESCRIPTION OF THE INVENTION

The goal of the invention is to provide an audible cue of low signal quality within the audio signal reproduced by a receiver in a digital wireless communication system. The audible cue preferably emulates the noise that is commonly present in the audio signal reproduced by a receiver in an analog wireless communication system. Such an audible cue will notify users of the receiver of the low quality of the received signal without the need to check a visual indicator. Preferably, an audible cue is injected into the reproduced audio signal when the signal quality falls below a predetermined threshold, that threshold selected to correspond to the point at which the user should begin to consider the need for corrective action if he or she does not wish to lose the signal. This point is largely subjective and can be selected based on so many potential criteria that it is difficult and inadvisable to attempt to define it. However, one possible choice is to choose the point that most closely corresponds to when noise would become audible in the reproduced audio signal had the receiver been an analog receiver.

Further, the nature of the injected audible cue is changed as a function of the signal quality. For instance, the injected cue can be increased in volume relative to the true received signal as the signal quality decreases. Even more preferably, the injected cue can emulate the sound of noise typically found in a received analog wireless signal of low quality, such as white noise or colored noise, (e.g., pink noise).

In an analog system, the noise that accompanies low signal quality comprises two main components, namely, static, which manifests itself essentially as white noise, and noise due to fading, which manifests itself essentially as pops and clicks in the audible signal. White noise is less obtrusive than fading noise in that clicks and pops, while of short duration, generally make it impossible for the human user to hear the portion of the actual signal that was reproduced simultaneously with the click or pop. On the other hand, the user typically can still discern the actual signal, i.e., the voice, when it is accompanied by only white noise. Accordingly, it is preferable to inject white noise, rather than fading noise in accordance with the present invention because it still primarily emulates typical analog channel noise, but is less intrusive and, in fact, can be controlled to always remain below a certain level that would be intrusive to the communication.

The invention provides substantial benefit in that digital wireless communication systems are commonly used by public safety officers such as police officers and fire fighters who often are not afforded the opportunity to view a visual indicator. The user of the receiver can then take whatever action may be advisable in view of the low signal quality, such as moving towards a window, if indoors, speaking more clearly and or repeating oneself or disregarding the radio and/or using other means of communication until the user is in a better location for radio communications.

The indicator of signal quality that is used to control the level of injected noise can be any reasonable indicator available in the receiver. For instance, digital wireless receivers typically use one or more algorithms for compensating for the loss of data, i.e., bits, in the communication stream due to low signal quality factors, such as radio frequency noise in the environment, weak signal, etc. Several general digital error correction schemes are in wide use today, including, for instance, Forward Error Correction (FEC), which is a scheme for detecting bits that probably or definitely have been received incorrectly and predicting what the actual bit value was in the original transmitted signal. Many FEC algorithms are known in the prior art. However, in all of them, the estimated number of errors that is occurring over any given period typically is an excellent indicator of the quality of the received signal. For instance, a bit error rate of less than 1% typically is indicative of a high quality received signal. Bit error rates in the range of 1%-3% usually indicate a decreasing signal quality nearing the point where the original signal cannot be recovered any more. Bit error correction rates in the range of 3%-5% indicate a very poor quality signal that is on the verge of being unrecoverable. By the time bit error rates reach 5%, a voice signal usually can no longer be reproduced with any reasonable level of accuracy. Nevertheless, while applying error correction algorithms such as FEC to a digital audio data stream, the poor quality of the signal is not manifested in the reproduced audible signal essentially until the quality so low that no useful voice signal can be reproduced (i.e., the signal is lost).

Another reasonable indicator of signal quality is known as received signal strength indicator (RSSI). Like FEC, RSSI is a somewhat generic term that encompasses many different precise algorithms, all of which generally can be considered as indicating the amplitude of a received signal. RSSI is a value that typically already is calculated in digital wireless receivers and, in fact, commonly is the value that is used to control the visual signal strength indicators that are found on many radios and cellular telephones. The quality of the received signal typically correlates highly with the RSSI. Particularly, for most of the range of this indicator, there is little degradation until the level falls close to the absolute sensitivity of the radio. At this point, signal quality rapidly drops until reception is no longer possible. However, there are many other environmental factors that can affect signal quality that are not accounted for in the RSSI value, particularly interference and fading, which are particularly an issue when the receiver (or transmitter) is not stationary. Accordingly, RSSI alone is not a very accurate indicator of signal quality.

However, RSSI has one significant advantage over BER as an indication of signal quality, namely, a much wider dynamic range. That is, in a practical environment, the spectrum between a near perfect signal (less than 1% BER) such that no noise should be injected into the signal and a signal that is of such poor quality that it can no longer be reproduced (about 5% BER) is a very narrow range. Typically, there is a much wider range between an RSSI indicative of a signal the quality of which has deteriorated to the point where the user should be made aware of it and loss of the signal.

Either BER or RSSI can be used as the signal quality indicator for determining the level of injection of noise. It is also possible to use a combination of both of these values. Therefore, in accordance with preferred embodiments of the invention, one or both of BER and RSSI are observed as an indication of signal quality.

When the signal quality drops below a certain threshold, a white noise generator begins to inject white noise into the received audio signal to emulate the response of an analog wireless communication channel to low signal quality. A colored noise generator also may be used. Preferably, as the signal quality further decreases from the threshold point, the volume of the white noise injected into the signal is increased to continually provide a precise indication of the received signal quality. The volume of the white noise injected relative to the signal should be adjusted so that it is barely audible at the threshold level and increases essentially linearly as the signal quality decreases. At no point should the volume of the injected white noise be enough to actually inhibit the ability to accurately hear the audible voice signals.

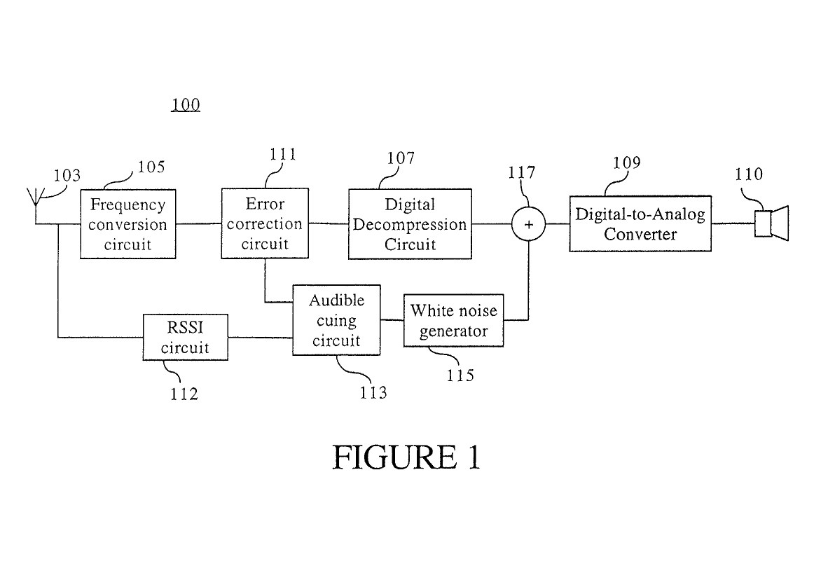

FIG. 1 is block diagram generally illustrating the components of the wireless digital receiver in accordance with the present invention. Of course, the invention can be applied and, in fact, is expected to be applied most frequently, in two-way radios, i.e., transceivers. However, FIG. 1 shows only the receiver portion of the device. The receiver 100 includes an antenna 103 that receives the bit stream, a frequency conversion circuit 105 that strips the carrier signal from the digital data stream, a decompression circuit 107 that decompresses the digital bit stream into a bit stream representative of the original analog signal, and a digital to analog converter circuit to convert the digital signal back to an analog signal which can then be provided to the speaker 110. Included in the receive path is an error correction circuit 111 that typically would be positioned between the frequency conversion circuit 103 and the decompression circuit 105 so as to receive the baseband digital bit stream. It performs whatever error correction is desired on the bit stream, typically including forward error correction. The circuit functions represented by blocks 105 and 111 typically would by performed by one or more digital signal processors (DSPs).

The bit error rate is fed to the noise injection circuit 113, which typically would be implemented by a DSP. Alternately or in addition, the received signal can be provided to the noise injection circuit 113 so that it also can determine an RSSI value. The noise injection circuit compares either the BER rate, the RSSI level or some value derived from both of them to a predetermined threshold. If the value exceeds that threshold, it activates a white noise generator circuit 115 to begin injecting white noise into the received signal, as illustrated by adder 117. In one embodiment of the invention, the volume of the injected white noise relative to the true received signal is increased linearly at some predetermined rate as the signal quality continues to decrease. When the signal quality reaches a second predetermined threshold indicative of the fact that the signal can no longer be reproduced sufficiently to generate a useful audio signal, the white noise generator 115 is deactivated to indicate to the user that communication is no longer possible. Alternately or in addition, the speaker 110 is muted.

As previously noted, alternately, the signal quality can be determined based on RSSI, which can be determined in circuit 112 and supplied to the audible cuing circuit 113. Also, as previously noted, the audible cuing circuit 113 may factor in both RSSI and BER rate into its determination of signal quality.

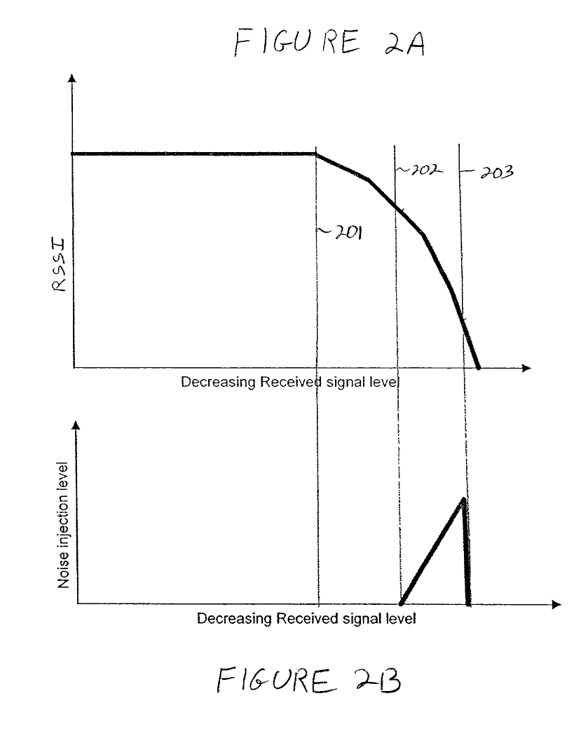

FIGS. 2A and 2B are graphs illustrating signal quality as a function of RSSI and noise injection as a function of signal quality, respectively, in accordance with one particular embodiment of the present invention. As shown in FIG. 2A, below a certain signal quality level generally indicated by line 201, RSSI is a reasonable indicator of signal quality. At some reasonable point after signal quality begins to decrease, such as the point indicated by line 202 in the graph, white noise injection in accordance with the present invention commences. As previously noted, in a preferred embodiment of the invention, at first, the volume of the white noise is increased linearly as a function of decreasing signal quality. At a second RSSI threshold indicated by line 203 in FIGS. 2A and 2B and corresponding to the point at which signal quality is likely so low that no usable voice information can be recovered, the white noise generator is turned off and/or the speaker is muted to make it clear to the user that the link has been lost.

In a static environment, e.g., an environment in which the receiver is not moving, an RSSI as low as −112 dBm might still produce a reasonably clear audible signal. However, in a dynamic environment, an RSSI of −112 dBm may result in a relatively low quality signal. Accordingly, in an embodiment that uses only RSSI, one might select a RSSI level of −90 dBm as a threshold for beginning to inject white noise and a RSSI level of −110 dBm as the point at which the speaker is muted.

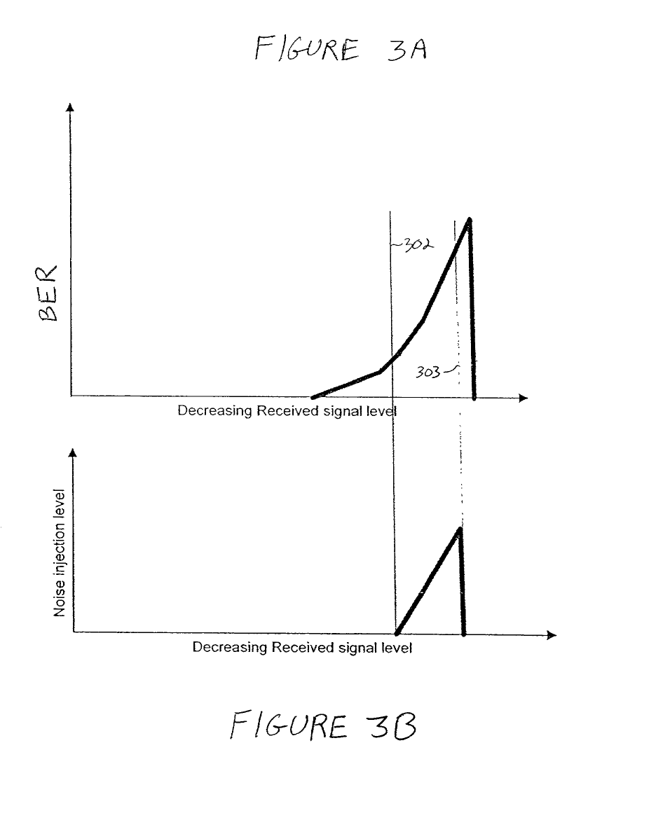

FIGS. 3A and 3B illustrate an alternative embodiment in which, instead of RSSI, the BER is used as the indicator of signal quality. As noted previously, this is a much more accurate indicator of signal quality because it takes into account environment-dependent factors that affect signal quality. However, it provides a much smaller dynamic range between near perfect signal quality reception and signal quality reception that is so poor that no usable voice information can be recovered. Nevertheless, the scheme is essentially the same. Particularly, there is a first threshold 302 set at a BER corresponding to the point at which the user should become concerned about signal quality. This point might be 1% BER. A second threshold 303 rate is set at the point that it is unlikely that any useful information can be recovered from the received signal, e.g., about 5% BER. As before, the noise injection commences at a low level at the first threshold 302, increasing linearly until the second threshold 303 is reached. At that point, the white noise generator is deactivated and/or the speaker is muted to give an abrupt audible indication that the communication channel has been disrupted.

The invention provides a continuously variable audible indication of signal quality. Further, the indication is emulative of the audible cues of low signal quality that are inherent in analog wireless communication systems and thus is intuitively recognized by users of analog radio equipment.

As previously noted, in an alternative embodiment of the invention, the algorithm for determining the amount of noise injection can be more complicated and can be based on a combination of RSSI and BER.

In one preferred embodiment of the invention, the receiver has a button that can be activated to eliminate the injection of white noise. In this manner, the user is notified of the existence of a low signal quality condition and yet can defeat the white noise if, perhaps, it is intrusive.

Another property that may be used as an indication of signal quality is frame erasure rate. Frame erasure rate also is frequently readily available in receivers.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A method of audibly indicating signal quality of a digital audio data signal, said method comprising the steps of:
(1) receiving a digital audio data signal;
(2) determining a quality of said digital audio data signal; and
(3) injecting an audible cue into said digital audio data signal if said digital audio signal is determined to be below a first threshold.

2. The method of claim 1 wherein said cue comprises white noise.

3. The method of claim 1 further comprising the steps of:
(4) adjusting a level of said audible cue as a function of said determined signal quality when said determined signal quality is below said first threshold.

4. The method of claim 3 wherein step (4) comprises adjusting said level of said audible cue as a linear function of a property that is dependent on said signal quality.

5. The method of claim 1 further comprising the step of:
(5) deactivating said audible cue if said signal quality is below a second threshold lower than said first threshold.

6. The method of claim 5 wherein step (5) further comprises muting said received audio signal.

7. The method of claim 1 wherein step (2) comprises determining a received signal strength indication.

8. The method of claim 1 wherein step (2) comprises determining a bit error rate on said received digital audio data signal.

9. The method of claim 1 wherein step (2) comprises determining a frame erasure rate of said received digital audio data signal.

10. The method of claim 1 wherein step (2) comprises determining both a received signal strength indication and a bit error rate and wherein said first threshold is a function of both said received signal strength indication and said bit error rate.

11. The method of claim 1 further comprising the step of:
(7) deactivating injection of said audible cue responsive to an operation of a user.

12. The method of claim 1 wherein step (1) comprises receiving said digital audio data signal wirelessly.

13. A wireless digital receiver comprising:
a circuit for receiving a digital audio data signal;
an audible cue signal generator;
a circuit for determining a signal quality of said digital audio data signal;
a circuit for converting said received audio data signal into an audio signal; and
a circuit for injecting an audible cue from said audible cue generating circuit into said audio signal as a function of said signal quality determined by said circuit for determining signal quality.

14. The receiver of claim 13 wherein said circuit for determining signal quality comprises a digital error correction circuit.

15. The receiver of claim 13 wherein said circuit for determining signal quality comprises a circuit for performing error correction on said digital audio data signal and wherein said circuit for performing error correction determines a bit error rate of said digital audio data signal.

16. The receiver of claim 15 wherein said error correction circuit is a forward error correction circuit.

17. The receiver of claim 13 wherein said circuit for determining signal quality of said digital audio data signal determines received signal strength indication.

18. The receiver of claim 13 wherein said circuit for determining signal quality of said digital audio signal comprises a circuit for determining a received signal strength indication and circuit for determining a bit error rate of said digital audio data signal and wherein said circuit for injecting said audible cue injects said audible cue as a function of both said received signal strength indication and said forward error correction rate.

19. The receiver of claim 13 wherein said circuit for generating audible cue comprises a white noise generator.

20. The receiver of claim 13 wherein said circuit for injecting adjusts a level of said audible cue as a function of said determined signal quality when said determined signal quality is below said first threshold.

21. The receiver of claim 13 wherein said circuit for injecting deactivates said audible cue injection if said determined signal quality is below a second threshold lower than said first threshold.

22. The receiver of claim 13 wherein said circuit for determining signal quality of said digital audio data signal determines a received signal strength indication.

23. The receiver of claim 13 wherein said circuit for injecting deactivates injection of said audible cue responsive to an operation of a user.
